(19) United States
(12) Patent Application Publication
(10) Pub. No.: US 2026/0266588 A1
(43) Pub. Date: Sep. 10, 2026

(54) DEVICE FOR CARRYING OUT AN OPTICAL COHERENCE TOMOGRAPHY

(71) Applicant: Heidelberg Engineering GmbH, Heidelberg (DE)

(72) Inventors: Andreas FRITZ-BOUTELEUX, Lübeck (DE); Ralf ENGELHARDT, Lübeck (DE); Lisa KUTZNER, Berlin (DE); Lars LUFT, Groß Grönau (DE)

(73) Assignee: Heidelberg Engineering GmbH, Heidelberg (DE)

(21) Appl. No.: 19/470,963

(22) PCT Filed: May 15, 2024
(86) PCT No.: PCT/EP2024/063353

§ 371 Date: Sep. 30, 2025

(30) Foreign Application Priority Data
Jun. 15, 2023 (DE) 10 2023 115 649.7

(51) Int. Cl. G01B 9/02091; G01B 9/02015; G01B 9/02055

(52) U.S. Cl. CPC G01B 9/02091; G01B 9/02016; G01B 9/02028; G01B 9/0203; G01B 9/02072

(57) ABSTRACT

The invention relates to a device for carrying out an optical coherence tomography (OCT), comprising an interferometer (1) with a sample arm (2), through which light can be guided to a sample (3) to be detected, a reference arm (4), through which light can be guided on a reference section, and a detector (5), by means of which light from the two arms (2, 4) that interferes with the signals can be detected. The aim of the invention consists in detecting and compensating for Z-drift of OCT signals produced by changes in temperature in a device for carrying out an optical coherence tomography, wherein said detection and compensation are preferably carried out automatically. With respect to said aim, the invention is characterized in that a calibrating target (6) is provided which is internal to the device and/or invariant with respect to the sample and to which light can be guided on a monitoring section (7).

The invention relates to a device according to the preamble of claim 1.

The designation optical coherence tomography (typically abbreviated by OCT) is understood to refer to an imaging method. Two-dimensional and three-dimensional images of light-scattering structures can be obtained using this method. In this method, light having a certain bandwidth is typically split into two partial beams in a beam splitter. The first partial beam is incident on the sample to be examined or the object, the second partial beam passes through a reference section. The light reflected from the sample or the object interferes with the reference beam. By way of signals from the interference, the sample can be examined with depth resolution, i.e. in the depth of the optical axis of the first partial beam, by so-called A scans.

An axial shift of an OCT image, which is to be attributed to changing temperature differences between sample arm and reference arm, is typically not compensated for.

It is disadvantageous in this case that therefore the absolute Z position of the OCT image varies with the temperature differences. Each calibration of the device which has a dependence on the Z position is therefore faulty or can be faulty. Readjustments of the Z position are possibly also necessary in devices which do not have calibration dependence.

The invention is therefore based on the object of identifying and compensating for the Z drift of OCT signals induced by temperature changes in a device for carrying out optical coherence tomography. The identification and compensation are preferably to take place in an automated manner.

The present invention achieves the above-mentioned object by way of the features of claim 1.

It has first been recognized according to the invention that a device-internal and/or sample-invariant calibration target has to be provided, to which light can be guided on a monitoring section.

Furthermore, it has been recognized that a Z calibration scan in relation to the fixedly positioned device-internal calibration target can be made very quickly during the actual imaging in this way. The Z calibration scan can preferably be carried out with the aid of a scanner.

It has been recognized against this background that the calibration target appears at various image depths if reference signals and sample signals come from components which are subjected to different temperatures or a reference section is subjected to a different temperature than the sample section.

Furthermore, it has been recognized that a suitable additional reference section can be introduced into the interferometer if the path lengths between the additional calibration target and the actual sample position differ beyond the OCT image depth.

Furthermore, it has been recognized that an OCT signal of the calibration target appears at a specific image depth which is detected, preferably automatically. The determined differences of the respective image depths also correspond to the shift in the actual imaging, since both reference sections and also both sample sections are each subjected to the same temperature changes.

Finally, it has been recognized that additionally occurring changes of the path length difference between reference signal and sample signal have to be taken into consideration or calibrated in order to be able to distinguish these changes from changes due to temperature drifts.

The monitoring section could completely or partially correspond to the sample arm or the sample section. In this way, the automatic compensation of temperature drifts can be carried out particularly reliably. The calibration target can be arranged in the sample arm.

A monitoring unit could be provided in the device, which detects an OCT signal of the calibration target at a specific depth of an OCT scan or OCT image as a shift relative to a reference point and changes the optical path length of the sample arm and/or the reference arm in a user-controlled manner, preferably by manually starting a measurement, or automatically, thus without the influence of an operating person, so that the OCT scan or the OCT image does not experience the shift of the OCT signal of the calibration target. Alternatively, the representation of the sample in a display unit could be adapted accordingly. In this way, OCT scans also always remain at the desired position in the Z direction. The determination of quantitative measurement data from the OCT data and a registration of different imaging modalities are likewise possible. Manual tracking is no longer necessary.

A path length changing unit for changing the optical path length of the light guided in the respective arm could be assigned to the sample arm and/or the reference arm. The adaptation of the path length can be carried out by an optical path length changing unit, a so-called delay line, located in the sample arm and/or reference arm. The length difference of sample arm and reference arm is adapted to balance the temperature drift. A Z drift of the OCT signal is automatically compensated for by the device.

The optical path lengths of the sample arm and the monitoring section could be equal or could differ by not more than the image depth. In this way, the compensation of temperature drift can be carried out particularly reliably with simple optical structure.

The optical path lengths of the sample arm and the monitoring section could be different and therefore two reference sections could be provided. In this way, it is possible to subject both reference sections and also the sample sections, namely the sample section of the examined sample and the sample section of the calibration target, thus the monitoring section, to the same temperature changes. The calibration target could be light scattering. It can be optically detected well in this way when it is irradiated by a light source.

The calibration target could be designed as a retroreflector. The device-internal calibration target has to be sufficiently strongly scattering. If it is designed as a retroreflector, it is designed so that it contributes to an improvement of the signal-to-noise ratio (SNR).

The calibration target can be placed in the focus with the aid of an additional lens.

The sample arm and the reference arm could be spatially separated from one another at least in some sections, wherein the device comprises an optics block in which the calibration target is arranged, wherein the sample arm and the monitoring section are at least partially or completely arranged in the optics block and wherein the reference arm is at least partially or completely arranged outside the optics block. The sample arm and the monitoring section can therefore be subjected essentially jointly or completely jointly to a first temperature, whereas the reference arm can be subjected essentially completely or completely to a second temperature. The optics block can be designed as a structural unit which is preferably movable.

By means of a monitoring unit, light could be able to be guided alternately or simultaneously onto the calibration target and onto the sample or into a section of the sample arm, which can be turned toward the sample. A Z calibration scan can be carried out in this way.

A monitoring unit could decouple a part of the light of the sample arm shortly before the end of a fiber-guided sample arm and guide it onto a fiber-coupled calibration target. In this way, the calibration scan can be carried out in a fiber-assisted manner. Fibers can maintain polarizations of light particularly well or suppress them in a defined manner. The interferometer can be constructed as a free beam optics unit or in fibers, wherein the structure in fibers is advantageous.

The monitoring unit could comprise at least one scanner, an optical switcher, or a coupler. A Z calibration scan can be carried out by a scanner. Reference arms can be switched in by switchers or couplers if they are required.

Light emitted from a light source could be able to be guided at a dividing unit both into the sample arm and into the reference arm, wherein light reflected from the sample can be returned coming from an optics block via the sample arm to a unifying unit for interference with light from the reference arm. In this way, a sample arm and a reference arm can be at least partially spatially spaced apart from one another.

Against this background, the sample arm could be divided into a first sample arm section and a second sample arm section, wherein a path length changing unit is arranged between the sample arm sections and wherein the path length changing unit is arranged between the dividing unit and the unifying unit. The path length changing unit can thus be arranged in a spatial area in which a different temperature prevails than in the spatial area in which the optics block is arranged.

Two reference arm sections could be able to be switched into the reference arm by a coupler or optical switcher in order to cause the respective reference arm section to be part of the reference arm. The reference arm can thus be embodied singly or doubly depending on the position of the calibration target.

A path length changing unit could be arranged in the reference arm between the dividing unit and the unifying unit. The path length changing unit can thus be arranged in a spatial area in which a different temperature prevails than in the spatial area in which the optics block is arranged.

Alternatively or additionally, a path length changing unit could be arranged in the reference arm between the dividing unit and a coupler or optical switcher. The reference arm can thus be embodied singly or doubly depending on the position of the calibration target.

The sample arm could be divided into a first sample arm section and a second sample arm section, wherein a path length changing unit is arranged between the sample arm sections and wherein the path length changing unit is arranged between the dividing unit and the optics block. The path length changing unit can thus be arranged in a spatial area in which a different temperature prevails than in the spatial area in which the reference arm is arranged. The path length changing unit can be placed toward the sample.

An arrangement could comprise a device of the type described here and a first spatial area, in which a first temperature prevails, and a second spatial area, in which a second temperature prevails, wherein an optics block to be spatially turned toward the sample to be detected is arranged in the second spatial area. In this way, a mobile separation of optical components is possible, so that one part of the optical components is subjected to a first temperature and another part of the optical components is subjected to a second temperature.

In the figures

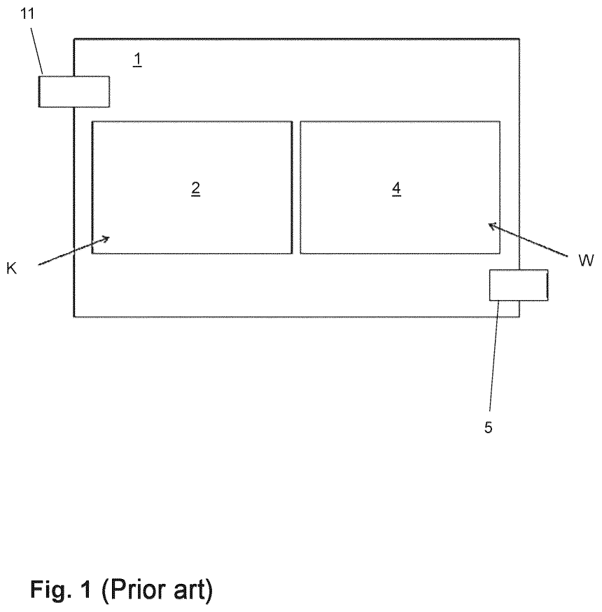

FIG. 1 shows a schematic view of an interferometer of the prior art in which the sample arm is subjected to a lower temperature, namely cold, and the reference arm is subjected to a higher temperature, namely heat,

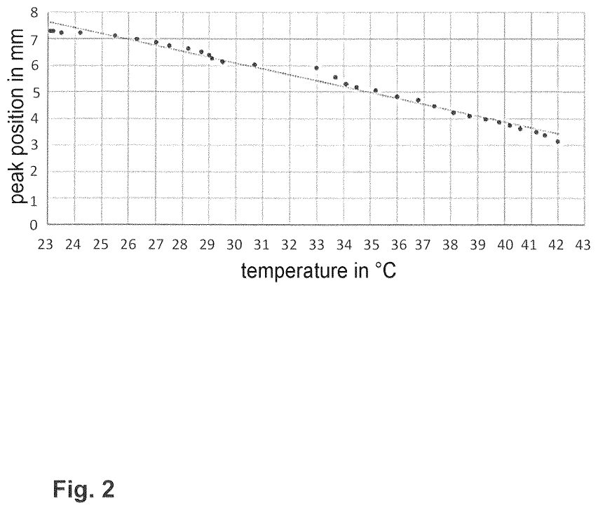

FIG. 2 shows a graphic representation of the dependence of a Z shift of an OCT signal on the temperature difference between sample arm and reference arm,

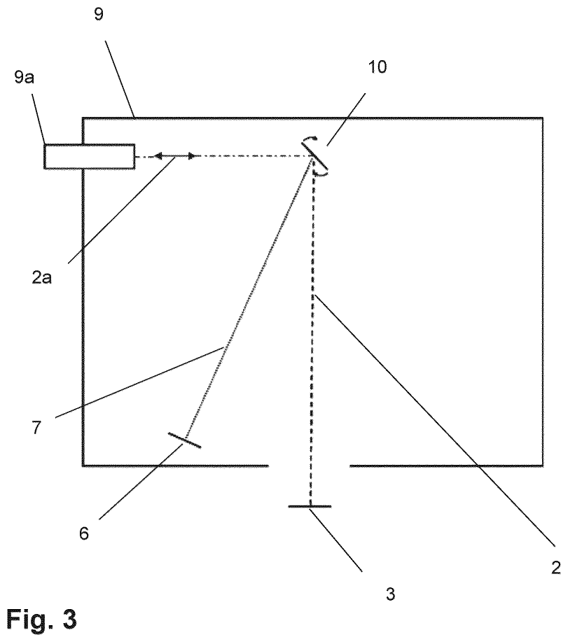

FIG. 3 shows a schematic view of an optics block which is expanded by a calibration target,

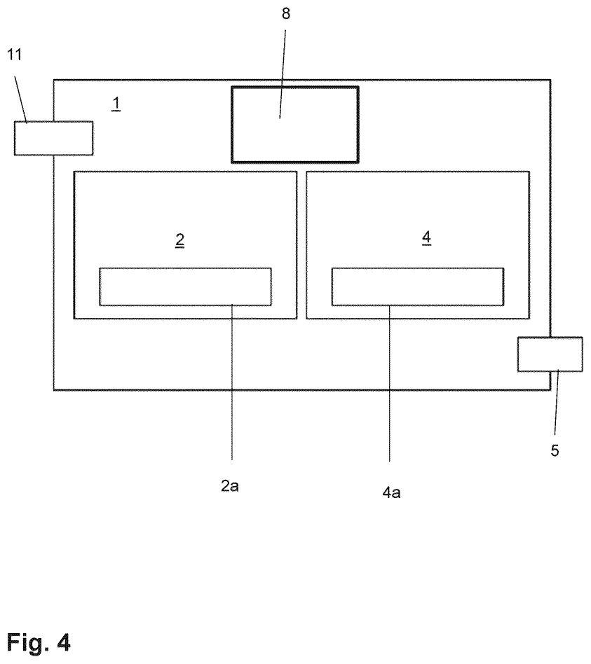

FIG. 4 shows a schematic view of an interferometer in which a path length changing unit is arranged both in the sample arm and in the reference arm,

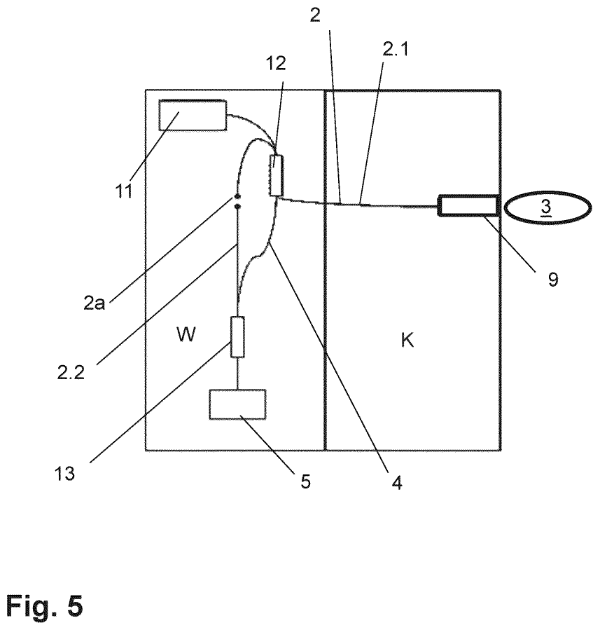

FIG. 5 shows a schematic view of a device in which the path length changing unit is arranged optically after the sample in the sample arm,

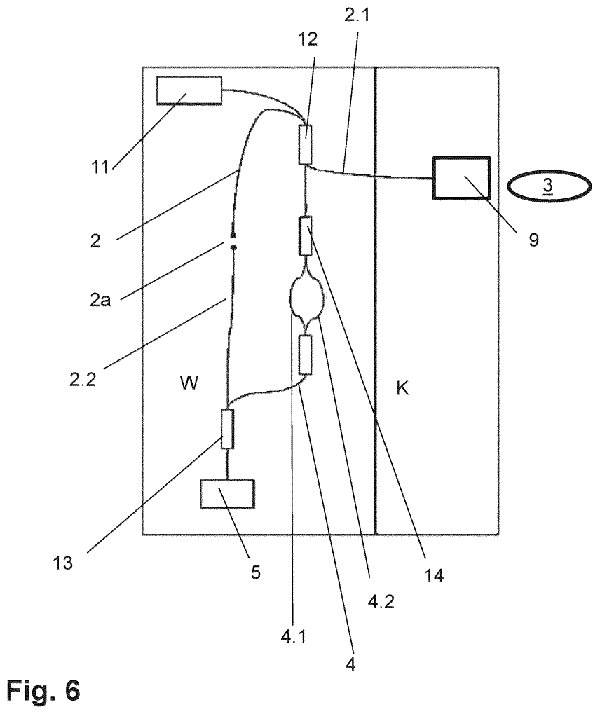

FIG. 6 shows a further schematic view of a device in which the path length changing unit is arranged after the sample in the sample arm, wherein the reference arm can be embodied doubled,

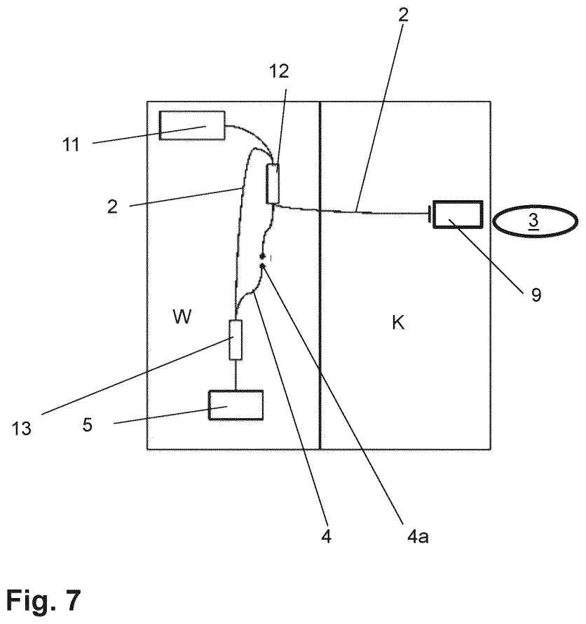

FIG. 7 shows a schematic view of a device in which the path length changing unit is arranged in the reference arm,

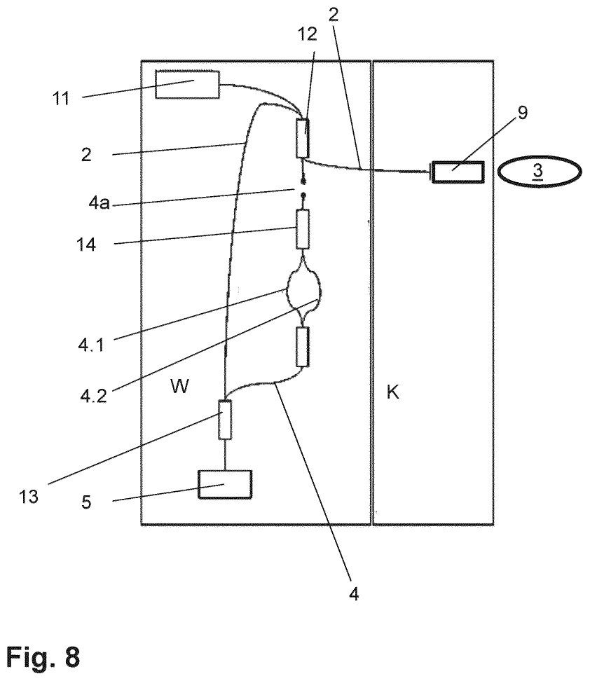

FIG. 8 shows a further schematic view of a device, in which the path length changing unit is arranged in the reference arm, wherein the reference arm can be embodied doubled,

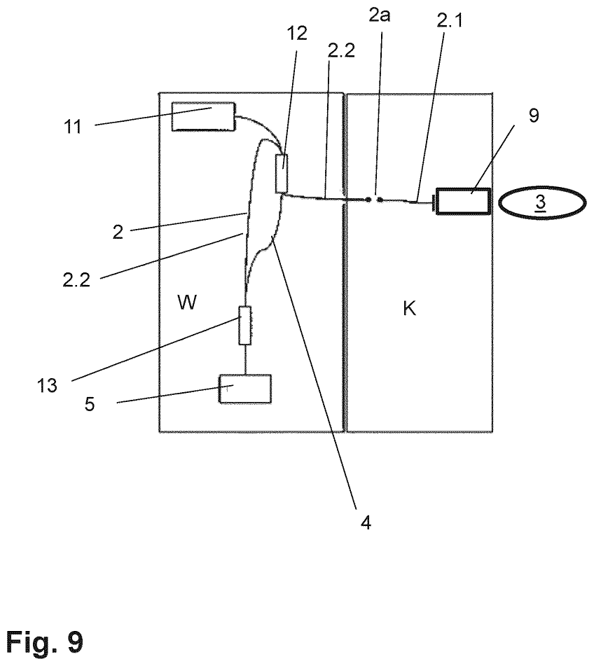

FIG. 9 shows a schematic view of a device in which the path length changing unit is arranged in the sample arm toward the sample, and

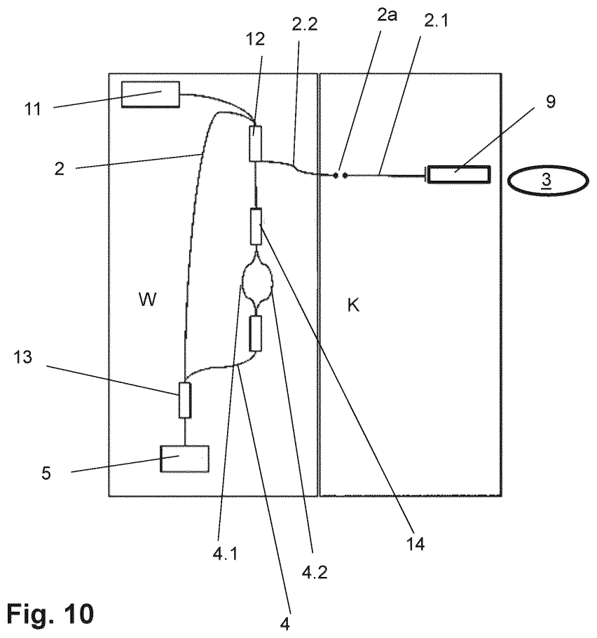

FIG. 10 shows a schematic view of a device in which the path length changing unit is arranged in the sample arm toward the sample, wherein the reference arm can be embodied doubled.

FIG. 1 shows a schematic view of a device for carrying out optical coherence tomography (OCT) of the prior art, comprising an interferometer 1 having a sample arm 2, through which light can be guided to a sample 3 to be detected, a reference arm 4, through which light can be guided on a reference section, and a detector 5, by which signals of interfering light from the two arms 2, 4 are detectable. Furthermore, a light source 11 is provided.

FIG. 1 insofar shows an arrangement of the prior art, comprising a device, a first spatial area W, in which a first temperature prevails, and a second spatial area K, in which a second temperature prevails. If the reference arm 4 and the sample arm 2 are spatially separated from one another in an interferometer, temperature differences can occur between these two units.

FIG. 2 shows the effects when the reference arm 4 is heated while the sample arm 2 is kept at room temperature. Measurements show that a temperature difference between the sample arm 2 and the reference arm 4 of the interferometer results in a Z drift or Z shift of the OCT signal.

FIG. 2 shows on the basis of a graphic representation that the Z drift is 4 mm upon heating if the sample arm length is 6 m and the heating is approximately 20 °C. The temperature is plotted in °C on the x axis of the diagram of FIG. 2, and a peak position of the OCT signal is plotted in mm on the y axis.

To compensate for the above-mentioned effect, the device according to FIG. 1 is expanded with a device-internal and/or sample-invariant calibration target 6, to which light can be guided on a monitoring section 7.

FIG. 3 shows the calibration target 6, which is assigned to an optics block 9, in which the sample arm 2 also extends. Light is guided on a monitoring section 7 to the calibration target 6. The monitoring section 7 can completely or partially correspond to the sample arm 2 or the sample section.

Against this background, FIG. 4 shows a schematic view of a device for carrying out optical coherence tomography (OCT), comprising an interferometer 1 having a sample arm 2, through which light can be guided to a sample 3 to be detected, a reference arm 4, through which light can be guided on a reference section, and a detector 5, by which signals of interfering light from the two arms 2, 4 are detectable.

In this device, a device-internal and/or sample-invariant calibration target 6 is provided, to which light can be guided on a monitoring section 7, as schematically shown in FIG. 3.

The optical path lengths of the sample arm 2 and the monitoring section 7 can be equal or can differ by not more than the image depth.

The calibration target 6 is light scattering. The calibration target 6 is designed as a retroreflector.

FIG. 4 furthermore schematically shows that a monitoring unit 8 is provided, which detects an OCT signal of the calibration target 6 at a specific depth of an OCT scan or OCT image as a shift relative to a reference point.

The monitoring unit 8 can change the optical path length of the sample arm 2 and/or the reference arm 4 in a user-controlled manner, preferably by manually starting a measurement, or automatically, thus without influence of an operating person, so that the OCT scan or the OCT image does not experience the shift of the OCT signal of the calibration target 6.

The monitoring unit 8 can alternatively change the optical path length of the sample arm 2 and/or the reference arm 4 so that the representation of the sample 3 in a display unit is adapted accordingly and does not experience a Z shift.

FIG. 4 furthermore shows in combination with FIG. 3 that to compensate for the above-mentioned thermal effect in the reference arm 4 and/or the sample arm 2, a path length changing unit 4a, 2a or also delay line is introduced in each case and the optics block 9 is expanded by the calibration target 6.

A path length changing unit 2a, 4a is assigned respectively to the sample arm 2 and/or the reference arm 4 to change the optical path length of the light guided in the respective arm 2, 4.

A path length changing unit 2a of the sample arm 2 can be assigned to the sample arm 2 or a path length changing unit 4a of the reference arm 4 can be assigned to the reference arm 4. It is also conceivable that a path length changing unit is assigned in each case to both arms 2, 4 if this is reasonable.

Light can alternately or simultaneously be guided onto the calibration target 6 and onto the sample 3 or into a section of the sample arm 2, which can be turned toward the sample 3, by means of the monitoring unit 8.

The monitoring unit 8 could decouple a part of the light of the sample arm 2 shortly before the end of a fiber-guided sample arm and guide it onto a fiber-coupled calibration target 6. A device having fiber structure is implementable in this way.

FIG. 3 furthermore shows that the monitoring unit 8 according to FIG. 4 comprises at least one scanner 10 to carry out a Z calibration scan.

FIGS. 5 to 10 each schematically show arrangements comprising a device, a first spatial area W, in which a first temperature prevails, and a second spatial area K, in which a second temperature prevails, wherein an optics block 9 to be spatially turned toward the sample 3 to be detected is arranged in the second spatial area K.

FIGS. 5 to 10 show on the basis of various exemplary embodiments of the device that the sample arm 2 and the reference arm 4 are spatially separated from one another at least in sections, wherein the device comprises an optics block 9, in which the calibration target 6 is arranged, wherein the sample arm 2 and the monitoring section 7 are at least partially or completely arranged in the optics block 9 and wherein the reference arm 4 is at least partially or completely arranged outside the optics block 9.

FIGS. 5 to 10 show that light emitted from a light source 11 can be guided at a dividing unit 12 both into the sample arm 2 and into the reference arm 4, wherein light reflected from the sample 3 is returnable coming from an optics block 9 via the sample arm 2 to a unifying unit 13 for interference with light from the reference arm 4.

In FIGS. 5 and 6, the sample arm 2 is divided in each case into a first sample arm section 2.1 and a second sample arm section 2.2, wherein a path length changing unit 2 a is arranged between the sample arm sections 2.1, 2.2 and wherein the path length changing unit 2a is arranged between the dividing unit 12 and the unifying unit 13.

In FIG. 6, two reference arm sections 4.1, 4.2 can be switched into the reference arm 4 by a coupler 14 or optical switcher in order to cause the respective reference arm section 4.1, 4.2 to become part of the reference arm 4.

FIGS. 5 and 6 specifically show that the path length changing unit 2a is placed in the sample arm 2 after the sample 3. The reference arm 4 has to be embodied singly or doubly depending on the position of the calibration target 6, wherein a second reference arm can be implemented or embodied here either by a coupler 14 or switch.

In each of FIGS. 7 and 8, a path length changing unit 4a is arranged in the reference arm 4 between the dividing unit 12 and the unifying unit 13.

In FIG. 8, a path length changing unit 4a is arranged in the reference arm 4 between the dividing unit 12 and a coupler 14 or optical switcher.

FIGS. 7 and 8 show that the path length changing unit 4a can be placed in the reference arm 4. The reference arm 4 has to be embodied singly or doubly depending on the position of the calibration target 6.

With two reference arm sections 4.1, 4.2, the path length changing unit 4 a has to be located in the common course of the reference arm sections 4.1, 4.2, wherein the second reference arm 4.2 can be implemented or embodied here either by a coupler 14 or switch. The path length changing unit 4a is therefore arranged optically before the splitting point, specifically before the coupler 14, in the reference arm 4.

In each of FIGS. 9 and 10, the sample arm 2 is divided into a first sample arm section 2.1 and a second sample arm section 2.2, wherein a path length changing unit 2 a is arranged between the sample arm sections 2.1, 2.2 and wherein the path length changing unit 2a is arranged between the dividing unit 12 and the optics block 9.

FIGS. 9 and 10 show that the path length changing unit 2a is placed in the sample arm section 2.1 toward the sample 3. It is to be noted here that the path length changing unit 2a displays a double stroke.

The reference arm has to be embodied singly or doubly depending on the position of the calibration target 6, wherein the second reference arm section 4.2 can be implemented or embodied here either by a coupler 14 or switch.

The optical path lengths of the sample arm 2 and the monitoring section 7 can be different, therefore two reference sections can be provided. The optical path length to the calibration target 6 is advantageously precisely as long as to the sample 3 so as not to require a second reference. In order to not increase the noise significantly and to reduce the signal-to-noise ratio of the actual sample signal as little as possible, the second reference arm section is to have as little power as possible or is to be implemented by a switcher.

The interferometer can be constructed as a free beam optics unit or in fibers, wherein the structure in fibers is advantageous. Furthermore, it is advantageous to position the calibration target 6 internally in the device.

### LIST OF REFERENCE SIGNS

1 interferometer
2 sample arm
2.1 first sample arm section
2.2 second sample arm section
2a path length changing unit of the sample arm
3 sample
4 reference arm
4.1 first reference arm section
4.2 second reference arm section
4a path length changing unit of the reference arm
5 detector
6 calibration target
7 monitoring section
8 monitoring unit
9 optics block
9a collimator
10 scanner
11 light source
12 dividing unit
13 unifying unit
14 coupler

1. A device for carrying out optical coherence tomography (OCT), comprising an interferometer (1) having a sample arm (2), by which light can be guided to a sample (3) to be detected, a reference arm (4), by which light can be guided on a reference section, and a detector (5), by which signals of interfering light from the two arms (2, 4) are detectable,
wherein a device-internal and/or sample-invariant calibration target (6) is provided, to which light can be guided on a monitoring section (7).

2. The device as claimed in claim 1, wherein the monitoring section (7) completely or partially corresponds to the sample arm (2) or the sample section.

3. The device as claimed in claim 1, wherein monitoring unit (8) is provided, which detects an OCT signal of the calibration target (6) at a specific depth of an OCT scan or OCT image as a shift relative to a reference point and changes the optical path length of the sample arm (2) and/or the reference arm (4) in a user-controlled manner, preferably by manually starting a measurement, or automatically, thus without influence of an operating person, so that the OCT scan or the OCT image does not experience the shift of the OCT signal of the calibration target (6), or that the representation of the sample in a display unit is adapted accordingly.

4. The device as claimed in claim 1, wherein path length changing unit (2a, 4a) for changing the optical path length of the light guided in the respective arm (2, 4) is assigned to the sample arm (2) and/or the reference arm (4).

5. The device as claimed in claim 1, wherein the optical path lengths of the sample arm (2) and the monitoring section (7) are equal or differ by not more than the image depth.

6. The device as claimed in claim 1, wherein the optical path lengths of the sample arm (2) and the monitoring section (7) are different and therefore two reference sections are provided.

7. The device as claimed in claim 1, wherein the calibration target (6) is light-scattering.

8. The device as claimed in claim 7, wherein that the calibration target (6) is designed as a retroreflector.

9. The device as claimed in claim 1, wherein the sample arm (2) and the reference arm (4) are spatially separated from one another at least in some sections, wherein the device comprises an optics block (9), in which the calibration target (6) is arranged, wherein the sample arm (2) and the monitoring section (7) are at least partially or completely arranged in the optics block (9) and wherein the reference arm (4) is at least partially or completely arranged outside the optics block (9).

10. The device as claimed in claim 1, wherein by means of a monitoring unit (8), light can be guided alternately or simultaneously onto the calibration target (6) and onto the sample (3) or into a section of the sample arm (2) which can be turned toward the sample (3).

11. The device as claimed in claim 1, wherein a monitoring unit (8) decouples a part of the light of the sample arm (2) shortly before the end of a fiber-guided sample arm and guides it onto a fiber-coupled calibration target (6).

12. The device as claimed in claim 1, wherein the monitoring unit (8) comprises at least one scanner (10), an optical switcher, or a coupler (14).

13. The device as claimed in claim 1, wherein light emitted by a light source (11) can be guided at a dividing unit (12) both into the sample arm (2) and into the reference arm (4), wherein light reflected from the sample (3) is returnable coming from an optics block (9) via the sample arm (2) to a unifying unit (13) for interference with light from the reference arm (4).

14. The device as claimed in claim 13, wherein the sample arm (2) is divided into a first sample arm section (2.1) and a second sample arm section (2.2), wherein a path length changing unit (2a) is arranged between the sample arm sections (2.1, 2.2) and wherein the path length changing unit (2 a) is arranged between the dividing unit (12) and the unifying unit (13).

15. The device as claimed in claim 13, wherein two reference arm sections (4.1, 4.2) can be switched into the reference arm (4) by a coupler (14) or optical switcher in order to cause the respective reference arm section (4.1, 4.2) become part of the reference arm (4).

16. The device as claimed in claim 13, wherein path length changing unit (4a) is arranged in the reference arm (4) between the dividing unit (12) and the unifying unit (13) and/or in that a path length changing unit (4a) is arranged in the reference arm (4) between the dividing unit (12) and a coupler (14) or optical switcher.

17. The device as claimed in claim 13, wherein the sample arm (2) is divided into a first sample arm section (2.1) and a second sample arm section (2.2), wherein a path length changing unit (2a) is arranged between the sample arm sections (2.1, 2.2) and wherein the path length changing unit (2a) is arranged between the dividing unit (12) and the optics block (9).

18. An arrangement, comprising a device as claimed in claim 13, first spatial area (W), in which a first temperature prevails, and a second spatial area (K), in which a second temperature prevails, wherein an optics block (9) to be spatially turned toward the sample (3) to be detected is arranged in the second spatial area (K).
